(19) United States
(12) Patent Application Publication
(10) Pub. No.: US 2005/0068303 A1
(43) Pub. Date: Mar. 31, 2005

(54) Key inputting circuit of electronic device

(75) Inventors: Chi-Yu Ho, Taipei (TW); Wen-Chin Yeh, Taichung City (TW)

Correspondence Address: BRUCE H. TROXELL, SUITE 1404, 5205 LEESURG PIKE, FALLS CHURCH, VA, 22041, US

(73) Assignee: Inventec Appliances Corp.

(21) Appl. No.: 10/673,365

(22) Filed: Sep. 30, 2003

(51) Int. Cl. G09G 5/00

(52) U.S. Cl. 345/168

(57) ABSTRACT

A key inputting circuit is disclosed herein. A key inputting circuit while pressing one of keys then an input reference voltage signal will have a predetermined voltage drop caused by a specific number of series resistances and a designated voltage signal will output to a CPU to determine which key is pressed.

### BACKGROUND OF THE INVENTION

(1) Field of the Invention

The invention relates to an electronic device, and more particularly to a key inputting circuit of the electronic device.

(2) Description of the Prior Art

Computer has become one of our essentials in the modern world. For instance, Personal Computer (PC), mobile phone, Personal Digital Assistant (PDA), multimedia players and Information Appliance (IA) all are based on the computer system. The basic architecture of the computer system comprises a control unit, a memory unit, an input unit and an output unit. Among the aforementioned units, the input unit is the only interface where user can communicate with the computer system. Such as keyboard, which is the most familiar device users are used to.

FIG. 1 is a schematic view of a conventional digital key scanning circuit comprising: a CPU 10 and a key scanning circuit 12. Notice, in FIG. 1, each key (SW1˜SW21) connects a unique combination of row (r1˜r5) and column (c1˜c5) wires. It is the combination of row and column that allow the CPU 10 supporting ten I/O ports (P.0˜P.9) to determine which key is pressed. The number of rows or columns may change in different keypads, but the basic idea remains the same.

Please referring to FIG. 1, the key scanning circuit 12 uses a twenty-one key matrix arranged at least as 5 rows of 5 columns. In the first key scanning operation cycle, we bring one row of the five (e.g. r1) low to see if any keys on that row are pressed. The five column inputs are then read to see if there are any lines low, if so, the corresponding key is pressed. It is important that only one row output be low at a time to correctly identify a single key press. The column inputs are all tied high to make the inputs high when no key is pressed. Then, we bring next row sequentially low to detect the state of key pressing.

From the aforementioned key scanning circuit, it should be noted while the number of keys are increasing, the architecture of corresponding key matrix is bigger. At that time, if both of the CPU 10 and the key scanning circuit 12 are mounted on same circuit board, the layout of the circuit is difficult to deal with. If space of the circuit board is available, it is not a big deal to layout. But if the CPU 10 and the key scanning circuit 12 have to mount on different circuit boards for some specific reasons (e.g. outward design) then there should be some wires or other types of transmission lines (e.g. flexible flat cable, flat cable, etc.) connecting between the CPU 10 and the key scanning circuit 12 to transmit signals. Such that the reliability of the transmission lines plays an important role in this kind of product having the digital key scanning circuit.

The more transmission lines increase the more risks users have to face. For example, when any of the transmission lines are pulled apart or almost off by external force, the signals can not completely transmitted between the CPU 10 and the key scanning circuit 12. Thereby mistakes or false function even more the short circuit will be occurred. And the more transmission lines exists, the condition goes to worse. Hence, the present invention provides a design of key inputting circuit which has fewer transmission lines to eliminate the drop of product reliability causing by transmission lines failure.

### SUMMARY OF THE INVENTION

The first object of the present invention is to provide a key inputting circuit of the electronic device.

The second object of the present invention is to provide a key inputting circuit which has fewer transmission lines connects between CPU and key inputting circuit.

All these objects are achieved by the present invention described below. A key inputting circuit comprising: a load resistance, a key inputting module, a potential comparator, and an A/D converter. The load resistance connects between a reference voltage source and a signal gathering terminal. The key inputting module connects between said signal gathering terminal and ground which is formed by a plurality of series resistances and a plurality of keys wherein one end of every said key are connected to said signal gathering terminal and the other end of every said key are individually connected to corresponding series connection nodes of said series resistances. The potential comparator is to compare said reference voltage signal and said designated voltage signal from said key inputting circuit and decide to enable said CPU or not. The A/D converter is to convert said designated voltage signal to digital unit and transmit to the CPU. While one of keys of said key inputting module is pressed, a predetermined voltage drop is caused by said load resistance and said series resistances corresponding to said pressed key then a designated voltage signal will output from said signal gathering terminal for a CPU to determine the value corresponding to said pressed key.

### BRIEF DESCRIPTION OF THE DRAWINGS

The present invention will now be specified with reference to its preferred embodiment illustrated in the drawings, in which

FIG. 1 is a schematic view of a conventional digital key scanning circuit;

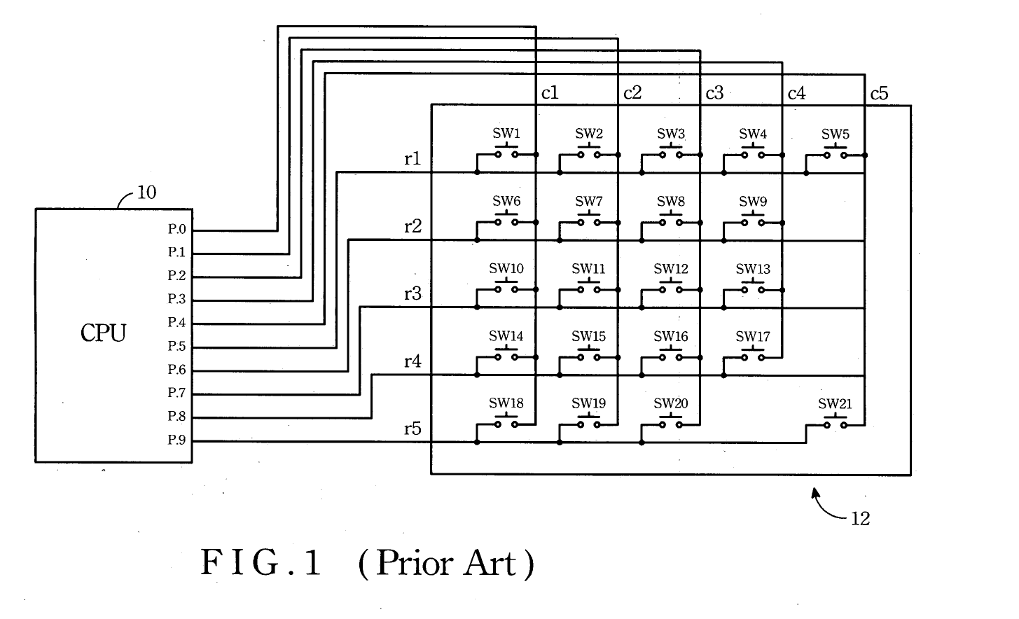

FIG. 2 is a schematic view of a key inputting circuit in accordance with the first embodiment of the present invention;

FIG. 3 is a schematic view of a key inputting circuit having twenty-one pieces of keys in accordance with the first embodiment of the present invention; and

FIG. 4 is a schematic view of a key inputting circuit in accordance with the second embodiment of the present invention.

### DESCRIPTION OF THE PREFERRED EMBODIMENT

The invention disclosed herein is a design of key inputting circuit embedded in an electronic device. In the present invention, while pressing one of keys then an input reference voltage signal will have a predetermined voltage drop caused by a specific number of series resistances and a designated voltage signal will output for CPU to determine the corresponding value of the pressed key. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

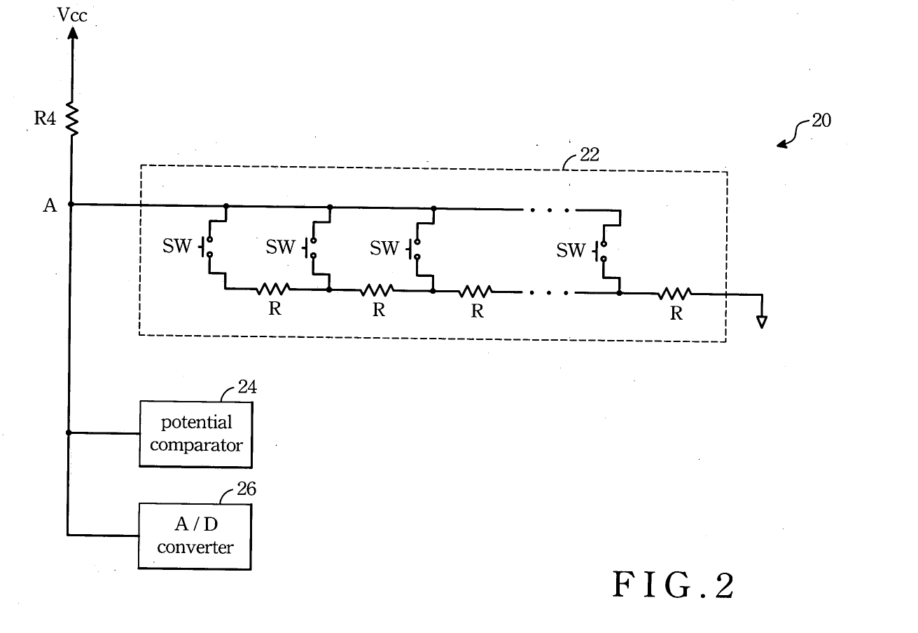

FIG. 2 is a schematic view of a key inputting circuit according to the first embodiment of the present invention. In this embodiment, the key inputting circuit 20 and the CPU (not shown) are arranged on the same circuit board. Referring to FIG. 2, the key inputting circuit 20 includes a load resistance R4, a key inputting module 22, a potential comparator 24, and an A/D converter 26. The load resistance R4 connects between a reference voltage source Vcc and a signal gathering terminal A. The key inputting module 22 connects between said signal gathering terminal A and ground.

And the key inputting module 22 is formed by a plurality of series resistances R and a plurality of keys SW. One end of every said key SW are all connected to said signal gathering terminal A. Besides, the other end of every said key SW are individually connected to the front end of the corresponding resistances then the back end of resistances are connected to the front end of next adjacent resistances R so that the plurality of resistances R are in series connection. Additionally, the last resistance R of said series resistances connects to ground. In the present embodiment, the resistances R are selected from the group consisting of carbon-film resistor, metal-film resistor, resistor network, and chip resistor. Furthermore, the potential comparator 24 and the A/D converter 26 are individually connected between the signal gathering terminal A and the CPU (not shown).

If no key of the key inputting circuit 20 is pressed, the key inputting module 22 will not conduct electricity and the potential comparator 24 will not output an enable signal to the CPU. On the contrary, if any key is pressed, the pressed key switches on then the resistance R connecting to the pressed key and other series resistances serial connected to ground are all conducting electricity. Therefore, a predetermined voltage drop is caused by said load resistance R4 and the aforementioned resistances in series connection so that a designated voltage signal will output from said signal gathering terminal A. However, the potential comparator 24 outputs a voltage signal according to the reference voltage source (Vcc) and said designated voltage signal to enable the CPU. Meanwhile, the A/D converter 26 converts said designated voltage signal into digital unit to CPU so that the CPU can determine the value corresponding to the pressed key in accordance with different key pressed has different output voltage signal.

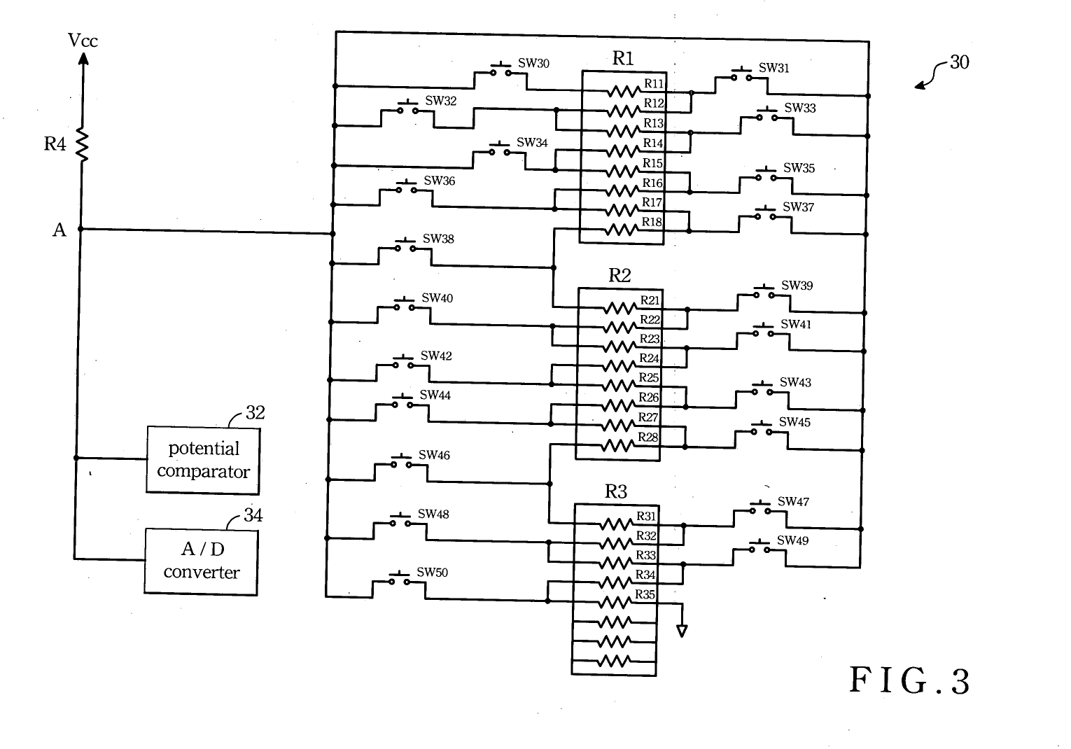

FIG. 3 is a schematic view of a key inputting circuit having twenty-one pieces of keys (SW30˜SW50) in accordance with the first embodiment of the present invention. While one key (e.g. SW34) on the key inputting module 30 is pressed, SW34 is on then the signal gathering terminal A will be detected an output voltage signal which is generated by series resistances (from resistance R15 to resistance R35). At this moment, the potential comparator 32 outputs an enable signal to CPU. And the A/D converter 34 converts the voltage signal from signal gathering terminal A into digital unit for CPU to determine the value corresponding to said pressed key. It should be noted, the resistances (R1—R2—R3) are resistor networks which have higher precision rate so that the output voltage signal will be more accurate for CPU to determine the corresponding value of the pressed key.

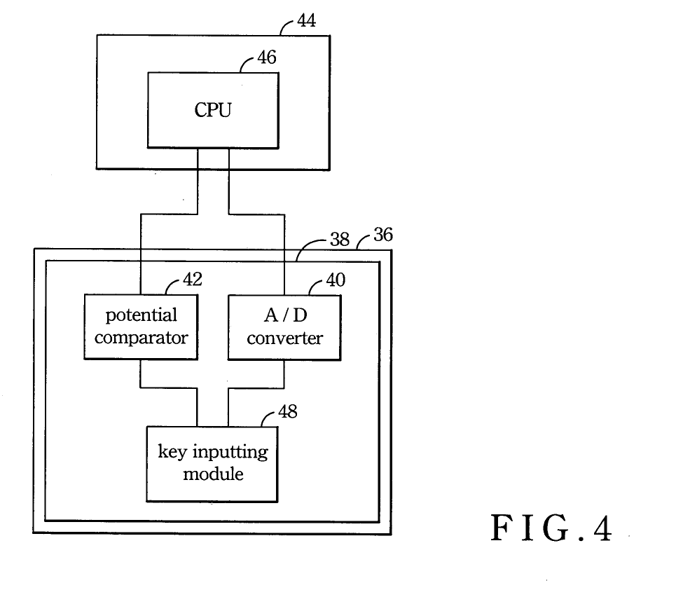

FIG. 4 is a schematic view of a key inputting circuit in accordance with the second embodiment of the present invention. In this embodiment, the CPU 46 is mounted on the first circuit board 44, and the second circuit board 36 which is arranged the key inputting module 48, the A/D converter 40, and the potential comparator 42. As soon as one of keys is pressed then an input reference voltage signal will have a predetermined voltage drop caused by a specific number of series resistances so that a first voltage signal will output to the A/D converter 40 then the A/D converter 40 converts the first voltage signal into digital unit to the CPU 46. Besides, the potential comparator 42 compares the reference voltage signal and the first voltage signal to output a second voltage signal thereby decide to enable said CPU or not. Through the first voltage signal and the second voltage signal, the key inputting circuit 38 (comprising the key inputting module 48, the A/D converter 40, and the potential comparator 42) and the CPU 46 can complete the communication between the first circuit board 44 and the second circuit board 36.

The aforementioned design in accordance with the present invention has several benefits below:

According to present invention, the transmission lines which communicate between the CPU and the key inputting circuit are reduced. Even though the number of keys increases, only two transmission lines are needed. It should be added that fewer transmission lines in electronic device (e.g. communication device, mobile phone) can save the layout space in circuit board design and match up the outward design to mount the CPU and the key inputting circuit on different circuit boards, especially eliminates the drop of product reliability causing by transmission lines failure and increases the flexibility of outward design.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as will as other embodiments, are intended to be included within the scope of the appended claims. The invention is defined by the following claims, with equivalents of the claims to be included therein.

1. A key inputting circuit while pressing one of keys then an input reference voltage signal will have a predetermined voltage drop caused by a specific number of series resistances and a designated voltage signal will output to a CPU.

2. The key inputting circuit according to claim 1 further comprises a potential comparator which is to compare said reference voltage signal and said designated voltage signal from said key inputting circuit and decide to enable said CPU or not.

3. The key inputting circuit according to claim 1 further comprises an A/D converter which is to convert said designated voltage signal to digital unit and transmits to said CPU.

4. The key inputting circuit according to claim 1, wherein said resistances are selected from the group consisting of carbon-film resistor, metal-film resistor, resistor network, and chip resistor.

5. A key inputting circuit comprising:
a load resistance connected between a reference voltage source and a signal gathering terminal; and
a key inputting module connected between said signal gathering terminal and ground which is formed by a plurality of series resistances and a plurality of keys wherein one end of every said key are connected to said signal gathering terminal and the other end of every said key are individually connected to corresponding series connection nodes of said series resistances
wherein one of the keys of said key inputting module is pressed and a predetermined voltage drop is caused by said load resistance and said series resistances corresponding to said pressed key then a designated voltage signal will be outputted from said signal gathering terminal for a CPU to determine the value corresponding to said pressed key.

6. The key inputting circuit according to claim 5 further comprises a potential comparator which is to compare said reference voltage signal and said designated voltage signal from said key inputting circuit and decides to enable said CPU or not.

7. The key inputting circuit according to claim 5 further comprises an A/D converter which is to convert said designated voltage signal to digital unit and transmits to said CPU.

8. The key inputting circuit according to claim 5, wherein said resistances are selected from the group consisting of carbon-film resistor, metal-film resistor, resistor network, and chip resistor.

9. An electronic device includes at least two circuit boards, a first circuit board and a second-circuit board, and a CPU is mounted on said first circuit board, said electronic device comprising:
a key inputting module which is arranged on said second circuit board, as soon as one of keys is pressed then an input reference voltage signal will have a predetermined voltage drop caused by a specific number of series resistances and a first voltage signal will be outputted to said CPU; and
a potential comparator which is to compare said reference voltage signal and said first voltage signal from said key inputting module and to output a second voltage signal thereby decide to enable said CPU or not;
wherein said first voltage signal and said second voltage signal can be transmitted through said first circuit board and said second circuit board thereby complete the communication between said key inputting module and said CPU.

10. The electronic device according to claim 9 further comprises an A/D converter which is to convert said first voltage signal to digital unit and transmit to said CPU.

11. The electronic device according to claim 9, wherein said resistances are selected from the group consisting of carbon-film resistor, metal-film resistor, resistor network, and chip resistor.

12. The electronic device according to claim 9, wherein said electronic device is a communication device.

13. The electronic device according to claim 9, wherein said electronic device is a mobile phone.
